(19) United States
(12) Patent Application Publication
(10) Pub. No.: US 2025/0201046 A1
(43) Pub. Date: Jun. 19, 2025

(54) COIN HOPPER

(71) Applicant: INNOVATIVE TECHNOLOGY LIMITED, OLDHAM (GB)

(72) Inventor: MARTIN SACKFIELD, MANCHESTER (GB)

(73) Assignee: INNOVATIVE TECHNOLOGY LIMITED, OLDHAM (GB)

(21) Appl. No.: 18/956,471

(22) Filed: Nov. 22, 2024

(30) Foreign Application Priority Data
Dec. 13, 2023 (EP) 23216414.5

(51) Int. Cl. G07D 1/06

(52) U.S. Cl. CPC G07D 1/06; G07D 2201/00

(57) ABSTRACT

A coin hopper for dispensing coins includes a container for holding coins, an exit channel for outputting a target number of coins, and a dispensing unit. The dispensing unit features a rotatable transport plate with multiple coin pockets, facilitating the transfer of coins from the container to the exit channel. These pockets accommodate coins of different sizes, with a first pocket for coins of a first size and a second pocket for coins of a second size. An adjustable cover on the transport plate allows selective exposure of the pockets to the container. The cover can move between two configurations: one exposing the first pocket while blocking the second, and the other exposing the second pocket while blocking the first. This design enables the coin hopper to dispense a target number of coins of varying sizes.

### FIELD OF THE INVENTION

The present invention relates to a coin hopper for dispensing coins and to a transaction machine comprising a coin hopper.

### BACKGROUND

Known coin hoppers for dispensing coins comprise a rotating disc. The rotating disc includes slots or pockets that correspond to the size and shape of coins to be paid out from the hopper. The size of the pockets in the disc correspond to the coin size being dispensed so that only one coin is dispensed by each pocket during each rotation of the disc. Therefore a particular hopper with pockets of a fixed size can dispense coins of a certain denomination or denominations. Manufacturers typically offer a range of discs with different pocket sizes. A particular hopper is fitted with a particular disc, during manufacture.

A coin hopper with a particular disc is thus configured to dispense a certain-sized coin based on the size of the pockets. In some coin hoppers, smaller coins may be dispensed using a disc comprising pockets which are configured for larger coins. However, the smallest coin size dispensable is generally limited to about 60% of the pocket diameter to ensure that two coins are not accidentally dispensed in one operation. Beyond this, the coin hopper cannot be used with other coin sizes without substantial modification. Such modification may typically include changing the disc provided in the coin hopper and potentially also changing payout area parts. Rebuilding the coin hopper in this way is a time-consuming and complicated process that requires a skilled technician.

Accordingly, there is a desire for a more adaptable coin hopper.

The present invention has been devised in light of the above considerations.

### SUMMARY OF THE INVENTION

Generally, the present invention relates to a coin hopper having a dispensing unit which is reconfigurable, by means of a movable cover, to transport coins of different sizes without replacing the entire dispensing unit.

Accordingly, in a first aspect, the present invention provides: a coin hopper for dispensing coins, the coin hopper comprising:
a container for holding a plurality of coins;
an exit channel for outputting a target number of coins from the plurality of coins; and
a dispensing unit, the dispensing unit including a rotatable transport plate located between the container and the exit channel, wherein the transport plate comprises a plurality of coin pockets, each coin pocket for receiving a dispense coin from the container, such that rotation of the transport plate causes the dispense coin to be transported from the container to the exit channel;
the plurality of coin pockets includes a first coin pocket configured to receive a dispense coin of a first size and a second coin pocket configured to receive a dispense coin of a second size, and
the dispensing unit further comprises a cover adjustably connected to the transport plate for selectively covering a portion of the transport plate,
wherein the cover is movable between a first configuration in which the first coin pocket is exposed to the container and the second coin pocket is blocked from the container by the cover, and a second configuration in which the first coin pocket is blocked from the container by the cover and the second coin pocket is exposed to the container, thereby permitting selective configuration of the coin hopper for dispensing the target number of coins of the first size in the first configuration or the target number of coins of the second size in the second configuration.

Advantageously, by providing coin pockets configured to receive coins of different sizes the coin hopper can be configured to dispense coins of different sizes (or denominations) without replacing the coin hopper or any parts thereof. In particular, the adjustable cover enables users to select and change the configuration of the coin hopper to dispense a particular size of coins which are being held in the container conveniently and more quickly than traditional coin hoppers. The first configuration may be considered a first position of the cover and the second configuration may be considered a second position of the cover.

The coin hopper, which may be referred to as a coin dispensing unit or a coin vending module, may be a sub-unit of a transaction machine for holding and outputting a target (predetermined) number of coins. The coin hopper may be configured to dispense coins of one denomination or physical size or shape. For example, if the container of the coin hopper is holding (or is intended to hold) relatively large coins (compared to other coins), then the dispensing unit may be configured to expose a coin pocket which is also large. However, if the container is holding relatively small coins, then a smaller coin pocket may be exposed. Therefore, a likelihood of the exposed coin pocket receiving and dispensing more than one dispense coin at a time may be reduced. Accordingly, the dispensing unit may transport one dispense coin in each exposed coin pocket at a time, until the target number of coins is dispensed.

The container, which may be referred to as a storage container or a bowl, may be an open-topped container for allowing coin entry. For example, the container may receive coins from a coin sorting module of a coin receive unit. The container may be configured to feed the plurality of coins towards the transport plate. For example, the container may have a gradient or slope which is configured to encourage the coins to slide or fall towards the transport plate.

The exit channel, which may be referred to as a coin chute, a payout chute, a dispensing channel, or a diverter channel, may be a conduit or passage configured to divert coins away from the transport plate. The exit channel may comprise a declining gradient such that a dispense coin transported to the exit channel by the transport plate may fall or slide down the channel under gravity.

The exit channel may be located above the container. Therefore, the transport plate may be configured to transport the coins upwards from the container towards the channel. Accordingly, a dispense coin which has fallen out of a coin pocket may fall back into the container.

The transport plate, which may be referred to as a rotation disc, a conveyer, or a coin transportation member, may be configured to receive a dispense coin from the plurality of coins in the container and deliver the dispense coin to the exit channel by lifting the dispense coin out of the container and rotating towards the exit channel. The target number of coins may be a value which is received from a processing unit and corresponds to a desired number of coins to be dispensed from the coin hopper. The transport plate may be configured to rotate until the target number of coins is dispensed.

The coin pockets (or coin slots) may be depressions or troughs having a predetermined depth and a predetermined diameter. The depth and/or the diameter of each type of coin pocket may be configured to correspond to certain a denomination of coin. For example, a cross-section of the coin pockets may be round. In some examples, one or more of the coin pockets may be circular. In more examples, one or more of the coin pockets may be, e.g., ovular or stadium-shaped. By configuring the size of each coin pocket to correspond to a particular size of coin (or a range of sizes of coins), the exposed coin pockets are particularly suited for dispensing a particular size of coin that is provided in the coin hopper. Accordingly the exposed coin pockets can be selected to be large enough to accommodate the coins provided in the coin hopper whilst not being so large that two coins may fit in each coin pocket.

Therefore, when the container is holding physically smaller coins, the size of the exposed coin pocket(s) may be configured to prevent multiple physically small coins from being received, side-by-side, in each exposed coin pocket at the same time. By ensuring that only single coins may be transported in each coin pocket, the coin hopper may be able to dispense the target number of coins more accurately. Rejected coins (e.g., coins which are stacked on top of another coin) which cannot fit into the coin pockets may fall back into the container.

The first coin pocket may be a larger coin pocket configured to transport physically larger coins, and the second coin pocket may be a smaller coin pocket configured to transport physically smaller coins. In this context, exposed is intended to refer to a coin pocket which is open to the container and configured to receive coins from the container when the transport plate rotates. Accordingly, by obscuring a portion of the transport plate with the adjustable cover, coins may be prevented from being received in coin pockets which are located under the cover.

The transport plate may be a circular disc. In other examples, the transport plate may be other shapes such as a polygon. The transport plate may be configured to rotate about a central shaft or post. The coin pockets may be disposed in the transport plate around the central shaft. The coin pockets may be spaced evenly around the transport plate.

The transport plate may include one or more first coin pockets each configured to transport a coin of a first size and one or more second coin pockets each configured to transport a coin of a second size. The cover may be movable between the first configuration in which the first coin pockets are exposed, and the remaining coin pockets are covered (blocked), and a second configuration in which the second coin pockets are exposed, and the remaining coin pockets are covered (blocked). Therefore, the dispensing unit may be configured to dispense coins of a size corresponding to the exposed coin pockets.

Accordingly, the transport plate may comprise; a plurality of first coin pockets each configured to receive a dispense coin of the first size, and a plurality of second coin pockets each configured to receive a dispense coin of the second size. In the first configuration the first coin pockets may be exposed to the container by the cover and the remaining coin pockets may be blocked from the container by the cover, and, in the second configuration, the second coin pockets may be exposed to the container by the cover and the remaining coin pockets may be blocked from the container by the cover. Accordingly, the first and second coin pockets may also be referred to as first and second types/classifications/categories/shapes of coin pockets. The adjustable cover may be configured to selectively expose one type of coin pocket thereby enabling the transport plate to transport coins corresponding to the exposed type of coin pocket. By providing multiple instances of each size of coin pocket, the coin hopper may dispense more coins during each rotation of the transport plate, thereby increasing the overall dispensing speed of the coin hopper.

The cover (which may also be referred to e.g., as a coin shield, an adjustable cover, a setting selection member, etc.) may be configured to enable the dispensing of one or more sizes of coins by selectively shielding or exposing one or more size of coin pockets in the transport plate. By moving the adjustable cover to the first or second (or additional) configurations, the dispensing unit may be configured to dispense coins of a size corresponding to the selected configuration (as determined by the exposed coin pockets in that configuration).

The coin hopper may further comprise a motor system configured to rotate the transport plate (and hence the dispense coin). The motor system may be configured to be operated by a controller; the controller being configured to control the dispensing unit of the coin hopper to dispense the target number of coins.

The dispensing unit may further comprise a stationary back plate. The transport plate may therefore be a front rotating plate or disc located in front of the stationary back plate. Therefore, in this example, the coin pockets may be apertures provided in the front plate which expose portions of the back plate. Accordingly, in use, the dispense coin received from the container may rest on and slide along the stationary back plate as the transport plate rotates.

An underside of the transport plate (i.e., a face of the transport plate which is proximal to the back plate and distal to the cover) may comprise a plurality of circumferentially (i.e., azimuthally extending) extending ribs located at a plurality of radial distances from a centre point of the transport plate.

The stationary back plate may comprise a diverter consisting of several diverter ribs or pegs protruding from the back plate near the exit channel which are arranged complimentary to the circumferentially (i.e., azimuthally) extending ribs of the transporter plate. The diverter ribs may extend from respective proximal rib ends which are proximal to the exit channel to respective distal rib ends which are located distally to the exit channel in the transport direction. The diverter ribs may be configured to interlace with the radially extending ribs of the transport plate as the transport plate rotates, thereby causing the diverter ribs to divert the dispense coin towards the exit channel for dispensing. That is, as the dispense coin slides along the back plate in the transport direction, it may come into contact with the distal ends of the diverter ribs protruding from the back plate. The diverter ribs may therefore prevent the dispense coin from continuing past the exit channel in the transport direction and instead divert the dispense coin towards the exit channel. The distal ends of the diverter ribs may be aligned with the exit channel to facilitate diversion of the dispense coin towards the exit channel. A height of the diverter ribs may be configured so that only one coin is diverted at a time.

The coin hopper may further comprise a spring-loaded singulator located proximal to the exit channel for enabling the dispense coin to be dispensed via the exit channel. The singulator may be configured to prevent multiple coins from being dispensed through the exit channel so that only one coin may be dispensed from each coin pocket during each rotation of the transport plate. More specifically, the singulator may comprise chamfered radial face a positioned across an entrance to the exit channel, i.e., between the transport plate and the exit channel. The singulator may therefore be configured to enable the dispense coin to pass underneath it, between the singulator and the back plate, into the exit channel and prevent excess coins from passing underneath into the exit channel.

The singulator may be spring loaded and biased towards the back plate such that the singulator can move or deform to allow thicker coins to pass underneath it and be dispensed, while preventing thinner coins which are located (stacked) on top of other coins from being dispensed. The chamfered radial face of the singulator may be configured to push excess coins which are stacked on top of the dispense coin away from the exit channel. The excess coin may then remain in the coin pocket, without passing into the exit channel, so that it may be transported around another revolution of the transport plate.

The transport plate may be inclined. For example, the transport plate may be mounted on an inclined back plate which is inclined. The transport plate may extend from the container towards the exit channel at an angle of between 0 degrees and 70 degrees, more preferably between 10 degrees and 60 degrees, more preferably between 30 degrees and 55 degrees, more preferably 55 degrees relative to a horizontal plane. This way, extraneous coins, i.e., additional coins received in a coin pocket in addition to the dispense coin, may fall away from the transport plate into the container more easily so that only single coins received in each coin pocket may be dispensed from the coin hopper. Additionally, the inclined angle can help to elevate the coins in the host machine, which is useful for transporting the coins around the host machine, and reduce motor load when the coin hopper is filled up with a large number of coins.

However, in some examples, the transport plate may not be inclined at all (i.e., the incline angle may be 0 degrees from a horizontal plane) or may be inclined at a shallower angle (e.g., between 5 degrees and 20 degrees, e.g., 10 degrees relative to horizontal). The present inventors have found that inclining the transport plate at a shallower angle can facilitate pickup of a final few coins remaining in the container since the coins may fall more readily into the coin pockets.

The transport plate may comprise one or more additional coin pockets configured to transport coins of one or more additional sizes. In this example, the adjustable cover is movable to one or more additional configurations wherein the one or more additional coin pockets are exposed, and the remaining coin pockets are covered. Each additional size of coin pocket may be configured to receive an additional (respective) size of dispense coin. Accordingly, the cover may be movable between a plurality of configurations to enable the coin hopper to dispense one of the sizes of coins in each configuration.

More specifically, the plurality of coin pockets may comprise a third coin pocket configured to receive a dispense coin of a third size. When the cover is in the first and second configurations, the third coin pocket may be blocked from the container by the cover. The cover may be movable to a third configuration in which the third coin pocket is exposed to the container, and the first and second coin pockets are blocked from the container by the cover.

The transport plate may comprise six coin pockets. The six coin pockets may comprise three different sizes of coin pockets arranged as opposing pairs around the transport plate. In other words, the six coin pockets may include a pair of first coin pockets configured to dispense coins of the first size, a pair of second coin pockets configured to dispense coins of the second size, and a pair of third coin pockets configured to dispense coins of a third size. Each pair of coin pockets may be located on opposing sides of the transport plate. More specifically, each coin pocket in a pair of coin pockets may be arranged on opposite sides of the transport plate. Therefore, the coin pockets may be arranged in an alternating order around the transport plate. The cover may be configured to selectively expose the first, or the second or the third coin pockets, and block the remaining coin pockets. Specifically, the cover may be movable between three different configurations, wherein each configuration exposes one of the pairs of coin pockets and covers the remaining four coin pockets.

More generally, the transport plate may comprise one, two, three, (or more) of each size of coin pocket, wherein coin pockets of the same type/size are spaced evenly around the transport plate. The present inventors have found that by separating coin pockets of the same type in this way, the transport plate may be more reliable at receiving coins in each exposed coin pocket during each rotation of the transport plate.

The coin hopper (or the plurality of coin pockets) may be configured to dispense coins of a diameter between 10 millimetres and 40 millimetres, for example between 14 millimetres and 33 millimetres. These dimensions advantageously cover a majority of worldwide coin denominations.

The cover may be movable between each configuration by rotation of the adjustable cover relative to the transport plate. The cover may have solid sections or portions which are filled, and exposing sections or portions which are each voids i.e., sections in which there is no material so that coins from the container may pass therethrough. In some examples, the cover may be a round plate comprising selection apertures or holes for exposing selected coin pockets in the transport plate. The selection apertures may be larger than each of the plurality of coin pockets in the transport plate. Therefore, coins may pass unimpeded through the apertures in the cover. In other examples, the cover may comprise one or more wedges (i.e., fins, blades, sectors, or segments) which are configured to selectively cover portions of the transport plate, wherein the fins or blades are separated by sectors which do not comprise any material. Therefore, rotation of the cover relative to the transport plate may cause the exposing sections of the cover to move relative to the transport plate thereby exposing various of the coin pockets at different rotational displacements of the cover.

The cover may be manually adjustable (i.e., by hand). For example, a user may be able to physically move the cover relative to the transport plate without using tools. Therefore, the coin hopper may be more quickly and efficiently reconfigured than traditional coin hoppers.

In another example, the cover may be configured to be automatically adjusted, for example by a drive unit configured to move the cover relative to the transport plate. For example, the cover may be automatically adjustable to a setting received from a controller of the coin hopper.

The cover may be configured to remain attached to the transport plate when it is being adjusted. For example, the cover may be connected to the transport plate via a central shaft. Therefore, the coin hopper may be reconfigured without removing or replacing any parts.

The coin hopper may further comprise a locking mechanism configured to lock the cover in each of the configurations. The locking mechanism may be located in a central portion of the transport plate and the cover. For example, the locking mechanism may include a central locking boss comprising a knob or gripping member connected to one or more locking arms. The locking arms may be tabs or protrusions which are configured to extend from the gripping member through respective openings in the cover and engage with the transport plate thereby securing the adjustable cover between the gripping member and the transport plate.

The locking boss may be movable between: a locked configuration in which the gripping member is flush with the cover, the cover is flush with the transport plate, and the locking arms are engaged with the transport plate thereby securing the cover to the transport plate, and an unlocked position wherein the gripping member is separated from (i.e., displaced/pulled away from) the transport plate thereby disengaging the locking arms from the transport plate and enabling movement of the adjustable cover relative to the transport plate. Therefore, when the gripping member is pulled away from the transport plate, e.g., by a user, the adjustable cover may be moved/rotated between configurations.

The locking arms may be configured to remain within the openings in the adjustable cover when the locking boss is in the unlocked configuration. The locking arms may be attached to the cover. Therefore, movement of the cover relative to the transport plate may result in a corresponding movement of the locking boss and vice versa, wherein movement of the locking boss may result in a corresponding movement of the cover. In other words, rotation of the gripping member, e.g., by a user, may result in rotation of the adjustable cover relative to the transport plate.

Alternatively or additionally, the locking mechanism may further comprise a locking screw (and corresponding screw holes in the transport plate and the back plate) which is configured to secure the transport plate to the back plate and prevent movement of the transport plate while the locking screw is installed. Accordingly, adjustment of the coin hopper by untrained persons or by accident may be prevented.

As mentioned above, the dispensing unit may further comprise a central post extending through the transport plate and the cover. The transport plate and the cover may be configured to rotate about the central post. The central post may engage with (i.e., is attached to) the locking boss such that movement (e.g., rotation) of the cover relative to the transport plate causes a corresponding movement of the central post.

The coin hopper may further comprise a detection mechanism for detecting the configuration of the adjustable cover. In some examples, the detection mechanism may be configured to communicate the detected configuration to a controller. In these examples, the coin hopper may comprise or be connected to a controller. The controller may be configured to compare the detected configuration to a desired configuration. Therefore, if the wrong configuration is set, the controller may be configured to generate an error message or a signal to indicate to the user that the coin hopper is in an incorrect configuration. For example, a desired configuration may correspond to a denomination of coins which is being held in the container and is set by a host machine of the coin hopper. If the detected configuration does not correspond to the desired coin denomination, then an error signal may be generated. In some examples, the controller may be configured to disable the coin hopper from dispensing coins until the correct configuration is detected.

In some examples, the detection mechanism may be configured to communicate the detected configuration (directly or via a controller) to an indicator unit. For example, the indicator unit may include one or more LEDs, a dial, or a display screen. For example, the coin hopper may comprise or be connected to one or more LEDs which are configured to light up depending on the detected configuration. In yet further examples, the coin hopper (i.e., the detection mechanism of the host machine) may be configured to communicate the detected configuration to a host machine.

The detection mechanism may comprise one or more flag arms configured to move relative to or synchronously with the cover. For example, the one or more flag arms may be connected to a central post which extends through the transport plate and engages with the adjustable cover and/or the locking mechanism. The one or more flag arms may extend radially from the central post on an underside of the transport plate which is distal to the cover. The central post may be connected to the cover (e.g., via the locking mechanism) such that rotation of the cover relative to the transport plate causes a corresponding rotation of the central post and the one or more flag arms. Accordingly, the flag arms can move with the cover to indicate the position of the cover relative to the transport plate. The detection mechanism may be configured to communicate the relative position of the flag arms to the controller and/or to an indicator unit.

In some examples, the detection mechanism may comprise two flag arms extending radially from the central post. Therefore, the detection mechanism may be able to detect the position of the cover by detecting one of the flag arms. Accordingly, the rotational position of the cover may be detected without needing to monitor an entire area surrounding the central post to detect a locking arm.

The detection mechanism may comprise a light pipe configured to determine a location of the flag arms relative to the transport plate. The light pipe may be an annular ring which is connected to the transport plate. In other examples, the relative positions of the flag arms may be detected using other means, e.g., including a mechanical trigger, conductive switches which may be opened and closed by the flag arms, capacitive or resistive sensors, etc.

An edge of the container proximal to the transport plate may comprise a resiliently biased bridging member which is configured to extend towards the transport plate. Accordingly, the container may be connected to, or brought closer to, the transport plate of the dispensing unit by the resiliently biased (e.g., sprung) bridging member. Therefore, in use, the transport plate may move relative to the container and the bridging member. The bridging member may be a retractable member which is configured to compress towards the container in reaction to a deformation force being applied between the transport plate and container. In coin hoppers which have containers with fixed edges, an object such as a stack of coins located in a coin pocket may cause the device to jam or undergo reverse rotation of the transport plate as the coin stack is wedged between the transport plate and the container. By providing a resiliently biased bridging member, the edge of the container (i.e., the bridging member) may resiliently deform in reaction to a jamming force, enabling the object or coins causing the jam to be moved past the container, thereby reducing a likelihood of the coin hopper becoming jammed or damaged.

In a second aspect of the present invention, there is provided an automatic transaction machine for administering monetary transactions, the transaction machine comprising a coin hopper for paying out coins according to the first aspect.

For example, the transaction machine may be a slot machine, a self-service check-out machine, a vending machine, kiosks, gaming machines, backoffice cash handling machines, etc.

In some examples, the transaction machine may comprise one or more additional coin hoppers according to the present invention. The transaction machine may be configured to dispense coins of multiple different denominations, wherein each coin hopper is configured to dispense coins of a respective denomination.

The transaction machine may further comprise an indicator unit configured to indicate a configuration of the one or more coin hoppers.

In a third aspect of the present invention, there is provided: a method of configuring a coin hopper for dispensing coins, the coin hopper comprising:
a container for holding a plurality of coins;
an exit channel for outputting a target number of coins from the plurality of coins; and
a dispensing unit, the dispensing unit including a rotatable transport plate located between the container and the exit channel, wherein the transport plate comprises a plurality of coin pockets, each coin pocket for receiving a dispense coin from the container, such that rotation of the transport plate causes the dispense coin to be transported from the container to the exit channel;
the plurality of coin pockets includes a first coin pocket configured to receive a dispense coin of a first size and a second coin pocket configured to receive a dispense coin of a second size, and
the dispensing unit further comprises a cover adjustably connected to the transport plate for selectively covering a portion of the transport plate,
wherein the method comprises:
moving the cover between a first configuration in which the first coin pocket is exposed to the container and the second coin pocket is blocked from the container by the cover, and a second configuration in which the first coin pocket is blocked from the container by the cover and the second coin pocket is exposed to the container, thereby configuring the coin hopper to dispense the target number coins of the first size in the first configuration or the target number of coins of the second size in the second configuration.

The coin hopper of the third aspect may include any of the optional features set out above for the first and second aspects.

For example, the method may further comprise: unlocking and locking the adjustable cover using the locking mechanism, wherein unlocking the adjustable cover comprises pulling a gripping member away from the transport plate. Moving the cover relative to the transport plate may comprise rotating the gripping member, when the locking boss is in the unlocked position, to thereby rotate the cover relative to the transport plate.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a block diagram of a monetary transaction system for receiving and dispensing coins, in accordance with the present invention;

FIG. 2 shows an example coin hopper according to the present invention;

FIG. 3 shows part of a coin hopper according to the present invention;

FIG. 5 shows an exploded view of parts of a coin hopper according to the present invention;

FIGS. 6-9 show additional views of a coin hopper according to the present invention;

FIG. 10 shows a diagram illustrating an example configuration of coin pocket sizes;

FIG. 11 shows a perspective view of example singulator part;

FIG. 12 shows a section view of part of a coin hopper according to the present invention;

FIGS. 13a-c show sectioned perspective views of part of a coin hopper according to the present invention; and

FIGS. 14-17 show perspective views of an example light pipe assembly.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

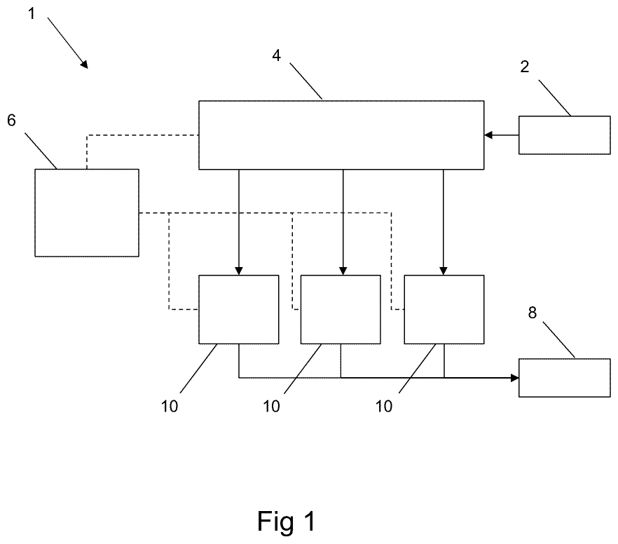

FIG. 1 shows a block diagram of an example monetary transaction system 1 for receiving and dispensing coins. For example, the system 1 may form part of a slot machine or a vending machine or self-service checkout.

A coin input chute 2 is provided for receiving a coin e.g., from a user wishing to initiate a monetary transaction. The coin is fed from the input chute 2 to a coin receive unit 4 which comprises a validation module for determining a denomination of the coin and a coin sorter unit for sorting the coin according to the determined denomination. If the coin receive unit 4 does not recognise the received coin, then the coin is rejected and fed back out of the system 1 via the coin input chute 2 or via a coin output chute 8. However, if the receive unit 4 does recognise the coin, then the sorting unit feeds the coin into one of a plurality of coin hoppers 10.

Each coin hopper 10 includes a container for holding a plurality of coins of a specific denomination. In this example, three coin hoppers 10 are shown. Therefore, if the inserted coin is recognised by the receive unit 4 then it is sorted into an appropriate one of the coin hoppers 10 according to the coin's denomination. In some examples, the plurality of coins may be provided to the coin hoppers 10 by another means, e.g., by opening up the system 1 to put a large number of coins in each coin hopper 10 for paying out as change later.

A controller 6 is provided to control the coin receive unit 4 and the coin hoppers 10. When multiple coins are inserted into the system 1, then the controller adds up the value of the coins and determines how many coins should be paid out of each coin hopper 10 as change.

The coin hoppers 10 are each configured to dispense a target number of the coins they are holding to the coin output chute 8. Therefore, if the controller determines that change is required from the monetary transaction, then a target number of coins is provided to each coin hopper 10. Each coin hopper 10 then dispenses that number of coins to the output chute 8.

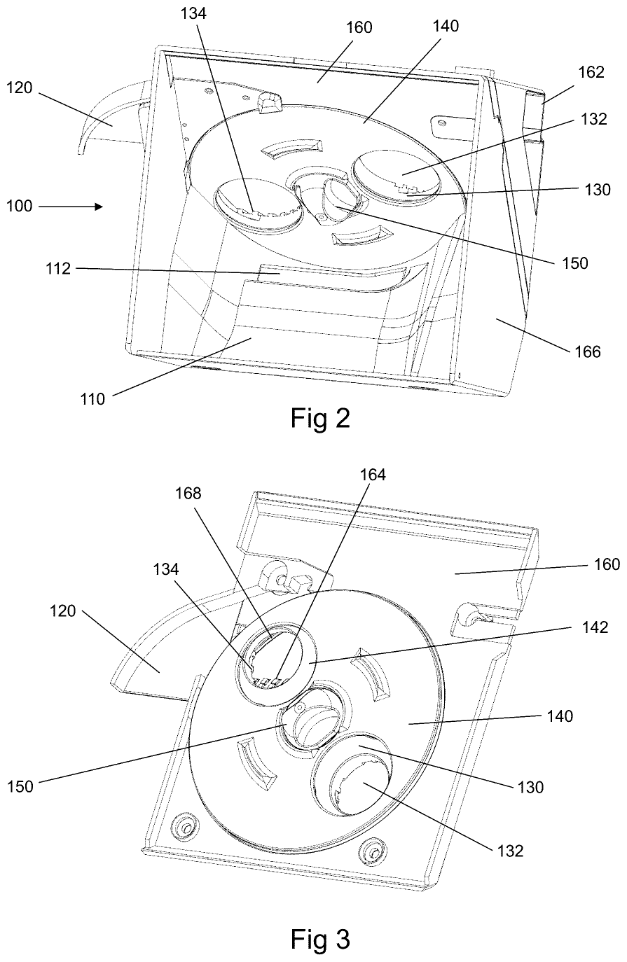

FIG. 2 shows an example coin hopper 100 for dispensing coins according to the present invention. The coin hopper 100 may be provided in an automatic transaction system such as the system of FIG. 1.

The coin hopper 100 comprises an open-topped container 110 for storing coins, an exit channel 120 for outputting coins, and a dispensing unit for transporting coins from the container 110 to the exit channel 120. The dispensing unit comprises a transport plate 130 mounted on an inclined back plate 160, and an adjustable cover 140 configured to partially obscure the transport plate 130. The coin hopper 100 is enclosed by a housing 166.

The container 110 is an open-topped bowl configured to feed coins towards a bottom portion of the transport plate 130. In use, the transport plate 130, which is a disc, is configured to rotate on the inclined back plate 160 and transport coins from the container 110 to the exit channel 120 for dispensing. A motor drive system (not shown) is provided to drive the transport plate 130 which is controlled by drive circuitry 162 located on a PCB in a rear area of the coin hopper 100.

The exit channel 120, which is mounted on the inclined back plate 160, is a conduit for diverting coins away from the transport plate 130 out of the coin hopper 100. The container 110 is located at the bottom of the device and the exit channel 120 is located above the container 110 in an upper region. Therefore, coins which fall out of the transport plate 130 may fall back into the container 110.

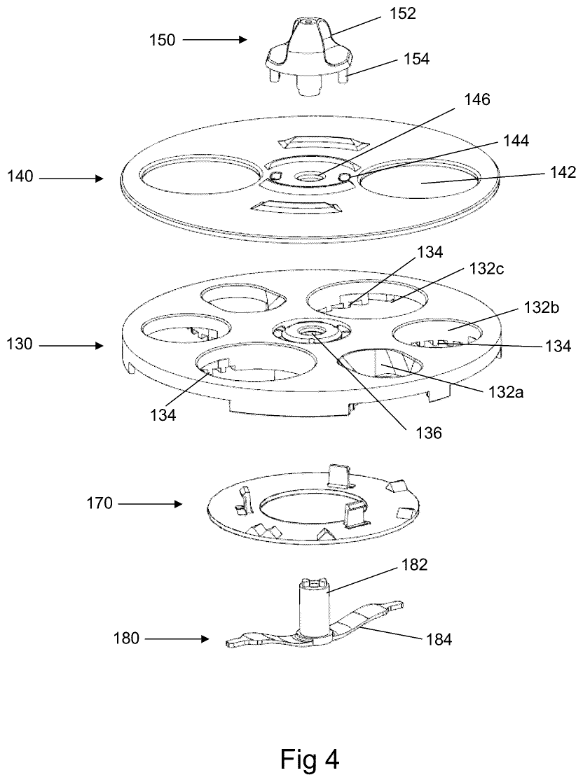

FIG. 3 shows a view of the transport plate 130, the inclined back plate 160, the adjustable cover 140, and the exit channel 120 without the container 110.

The transport plate 130 comprises a plurality of coin pockets 132. The coin pockets 132 are round apertures in the transport plate which are configured to receive coins from the container 110. The coins received in the coin pockets 132 can rest on the inclined back plate 160 and, as the transport plate 130 rotates, the coins are pushed along the back plate 160 towards the exit channel 120.

An underside of the transport plate 130 comprises a plurality of circumferentially extending ribs 134 located at a plurality of radial distances from a centre point of the transport plate 130. The inclined back plate 160 comprises a diverter 164 consisting of several diverter 164 ribs protruding from the back plate 160 near the exit channel 120. The diverter ribs 164 are arranged in complementary positions to the circumferentially extending ribs 134 of the transport plate 130. As coins are transported towards the exit channel 120 by the transport plate 130, the diverter ribs 164 are configured to interlace with the circumferentially extending ribs 134 thereby diverting coins resting on the back plate 160 towards the exit channel 120. A height of the diverter ribs 164 is configured so that only one coin is dispensed at a time.

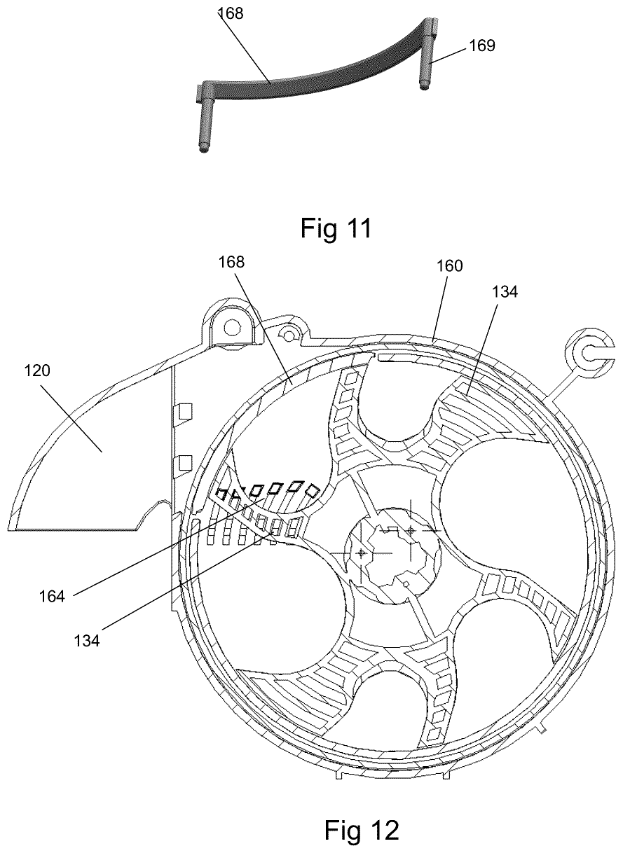

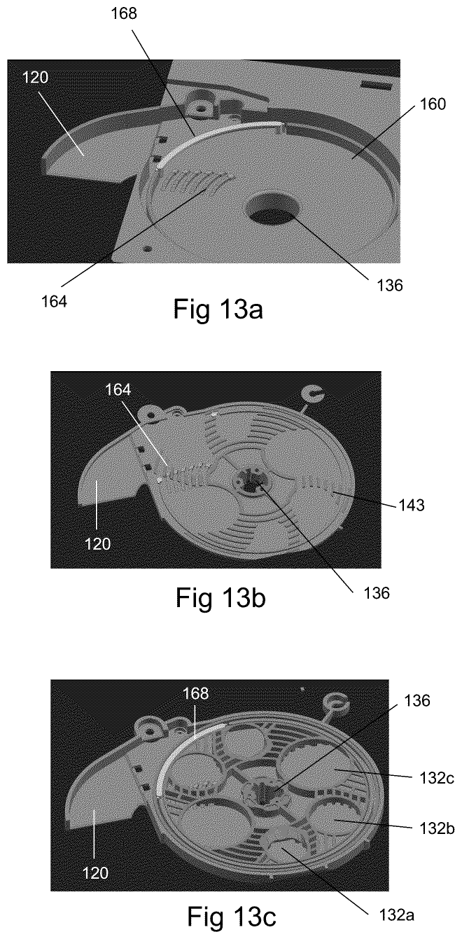

The coin hopper 100 further comprises a spring-loaded singulator 168 located proximal to the exit channel 120. The singulator 168 is configured to deform away from the back plate 160 to allow thicker coins to be dispensed and to push thinner coins located on top of other coins back into the container 110. Therefore, the coin hopper 100 is prevented from dispensing multiple coins at the same time. The singulator 168 is shown in more detail in FIGS. 11 and 12.

As mentioned above, the coin hopper 100 comprises an adjustable cover 140 which is mounted to the transport plate 130. The cover 140 includes apertures 142 so that the cover 140 can be selectively configured to obscure a portion of the transport plate 130 thereby obscuring some of the coin pockets 132 so that they cannot be used to transport coins.

FIG. 4 shows an exploded view of the coin hopper 100. In FIG. 4 the inclined back plate 160 and the drive gear, which would normally be located between the light pipe assembly 170 and the transport plate 130, are not shown.

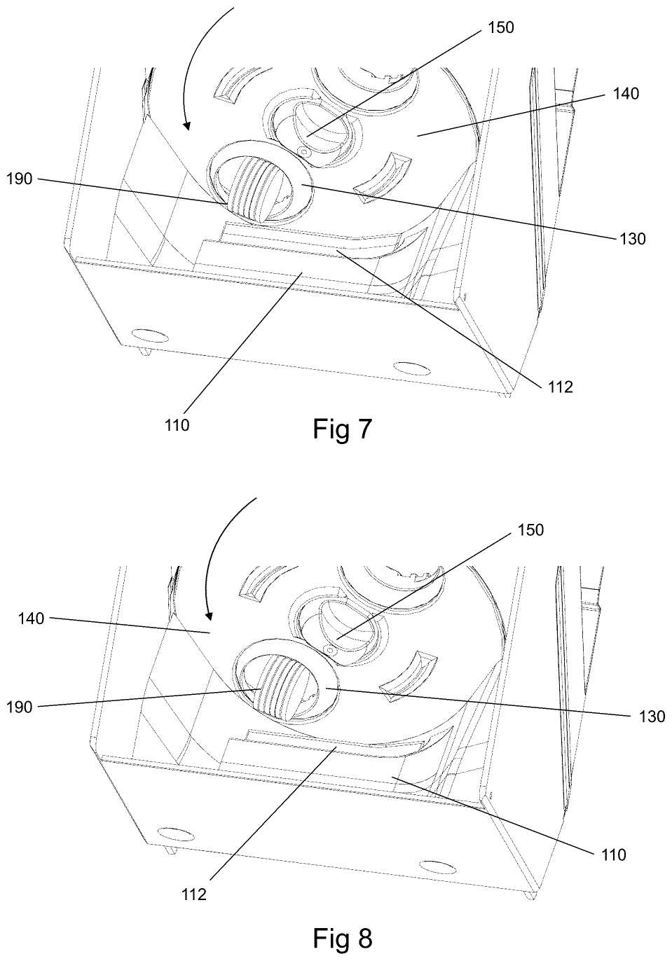

The transport plate 130 of FIGS. 2-8 includes six coin pockets 132 of three different sizes. Specifically, the transport plate 130 includes a pair of first small coin pockets 132a configured to transport small-sized coins, a pair of second medium coin pockets 132b configured to transport medium-sized coins, and a pair of third large coin pockets 132c configured to transport large-sized coins.

The adjustable cover 140 is configured to cover 140 two such pairs of coin pockets 132 while exposing the remaining pairs of coin pockets 132, thereby configuring the coin hopper 100 to dispense coins of a size which corresponds to the exposed coin pockets 132. The adjustable cover 140 is configured to be rotated relative to the transport plate 130 between first, second and third configurations so that one of the pairs of coin pockets 132 is exposed in each configuration.

A locking mechanism is provided to secure the adjustable cover 140 into one of the three configurations. The locking mechanism includes a central locking boss 150 comprising a gripping member 152 connected to one or more locking arms 154 or tabs. The locking arms 154 are configured to pass through respective openings 144 in the adjustable cover 140 and engage with the transport plate 130 thereby securing the adjustable cover 140 between the gripping member 152 and the transport plate 130.

The gripping member can be pulled away from the transport plate 130 into an unlocked position and pushed back towards the transport plate 130 into a locked position.

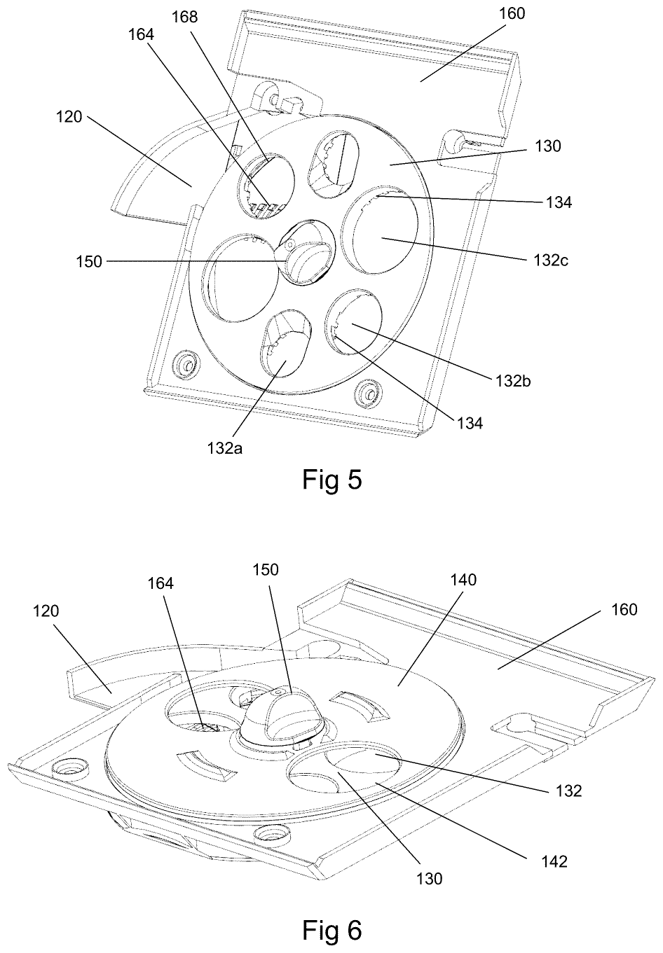

FIG. 5 shows the gripping member 152 in the locked position. The gripping member 152 is flush with the cover 140, the cover 140 is flush with the transport plate 130, and the locking arms 154 are engaged with the transport plate 130 thereby securing the cover 140 between the gripping member 152 and the transport plate 130.

FIG. 5 shows the gripping member 152 in the unlocked position. The gripping member 152 is pulled away from the transport plate 130 thereby disengaging the locking arms 154 from the transport plate 130 and enabling movement of the adjustable cover 140 relative to the transport plate 130. When the gripping member 152 is in the unlocked position the locking arms 154 remain within their respective openings 144 in the cover 140 such that movement of the cover 140 relative to the transport plate 130 results in a corresponding movement of the locking boss 150 and vice versa.

The gripping member 152 is also attached to a central post 182 which extends through central holes 136, 146 in the transport plate 130 and the cover 140. Therefore, rotation of the gripping member 152, when it is in the unlocked position, relative to the transport plate 130 causes a corresponding rotation of the cover 140 and the central post 182 relative to the transport plate 130.

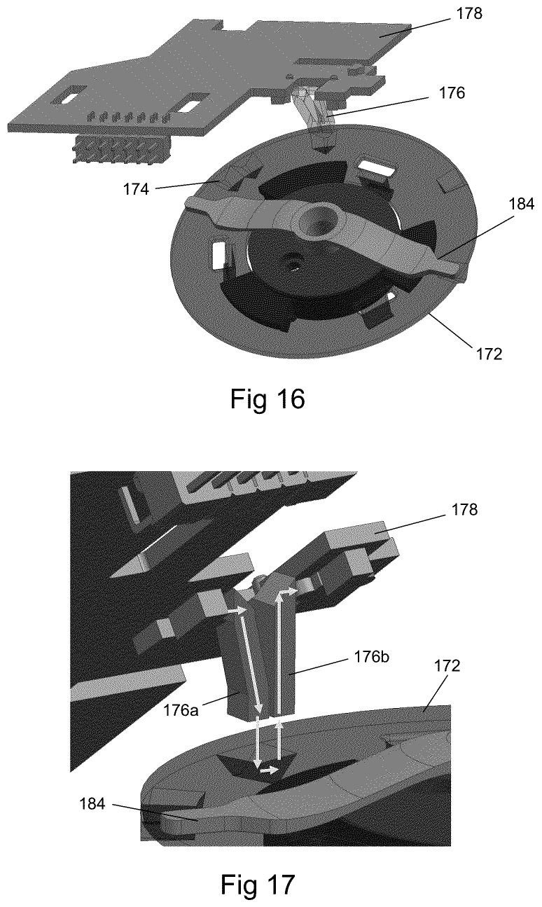

The central post 182 comprises two flag arms 184 extending radially outward to form part of a detection mechanism 180 for determining the configuration of the adjustable cover 140. A light pipe arrangement 170 is provided to determine the position of the flag arms 184 relative to the transport plate 130 and therefore determine the selected configuration of the adjustable cover 140. The light pipe arrangement is described in more detail below in relation to FIGS. 14 and 15.

In this way, the coin hopper 100 can sense which coin pocket size is currently exposed to the container (via the flag arms 184 connected to the gripping member 152 of the locking boss 150) and can communicate this to a host machine to prevent operation of the hopper 100 with the wrong coin size. For example, an error may be communicated to a user using an indicator such as a display screen or an LED. In other examples, the coin hopper 100 may be disabled so that it cannot be used until the cover 140 is detected in the correct configuration.

FIGS. 7 and 8 show additional views of the coin hopper 100 of FIG. 2 where an orthogonal stack of coins 190 is located in a coin pocket 132 of the transport plate 130. This can happen before the transport plate 130 starts rotating.

An edge of the container 110 proximal to the transport plate 130 comprises a sprung bridging member 112 which extends towards the transport plate 130. The bridging member 112 is configured extend towards the transport plate 130 in the absence of any external force and compress towards the container 110 in reaction to a jamming force acting between the container 110 and the transport plate 130. Therefore, if an object, such as the stack of coins 190 shown in FIGS. 7 and 8, is located in a coin pocket 132, the object can deflect the bridging member 112 towards the container 110 (as shown in FIG. 8) as the transport plate rotates 130 past the container 110 thereby reducing a likelihood of the coin hopper 100 jamming.

FIG. 9 shows a perspective, sectioned view of the coin hopper 100 where the bridging member 112 can be seen extending from the container 110 towards the transport plate 130. In this example, the bridging member 112 is configured to leave a gap between the bridging member 112 and the transport plate 130 thereby preventing any restriction on the movement of the transport plate 130 or the motor load.

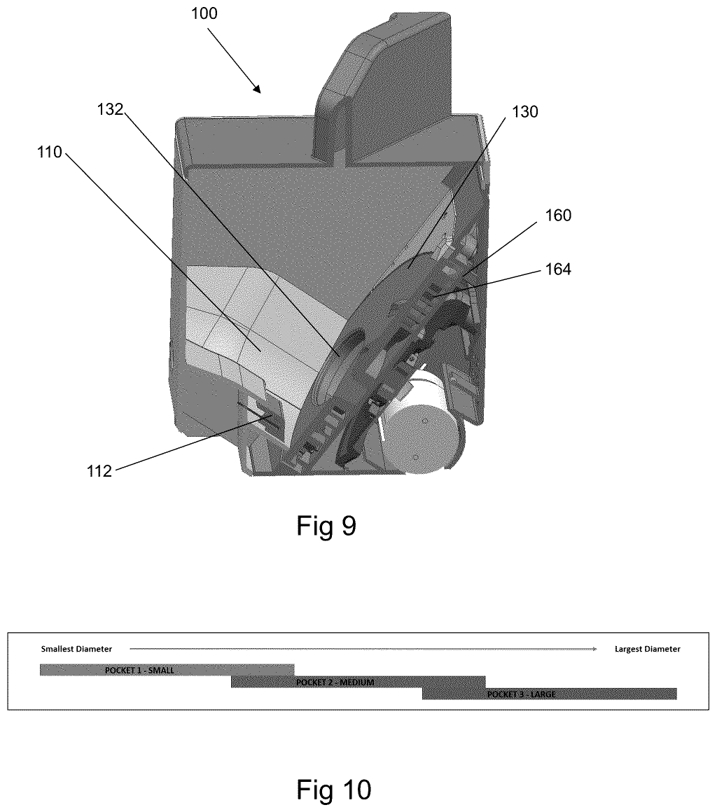

FIG. 10 shows a diagram of example configurations of three coin pocket sizes: small, medium, and large which are arranged in order of increasing coin diameter that each size of coin pocket can accept. As shown in FIG. 10, the coin sizes acceptable by each coin pocket are configured to overlap. For example, some coins may be suitable for dispensing by the small or the medium coin pockets, and some coin sizes may be suitable for dispensing by the medium or the large coin pockets.

FIG. 11 shows the spring-loaded singulator 168 mentioned above for preventing multiple coins from being dispensed through the exit channel. The singulator 168 is also shown in FIG. 12 which shows a sectioned view of the transport plate 130, the back plate 160 and the exit channel 120. In this example, the transport plate 130 has been sectioned through the circumferentially extending ribs 134 located on the underside of the transport plate 130. Also shown is the diverter ribs 164 for diverting coins towards the exit channel 120.

As shown in FIGS. 11 and 12 the spring-loaded singulator 168 is a radial member located proximal to (i.e., across the entrance to) the exit channel 120 and includes a chamfered radial face which is configured to allow a coin to slide underneath the singulator 168 (i.e., between the singulator 168 and the back plate 160). The singulator 168 comprises two sliding pins 169 which are configured to allow the singulator to move up and down in two holes provided in the back plate 160. The singulator 168 is spring-loaded towards the back plate 168 and made of wear resistant material. The coin facing face (i.e., the chamfered radial face) of the singulator 168 is angled such that a coin can be pushed underneath the insulator thereby causing the singulator 168 to move away from the back plate 160. However, excess coins which are stacked on top of the dispense coin are pushed away from the exit channel 120 by the singulator 168 so that they fall back into the container 110.

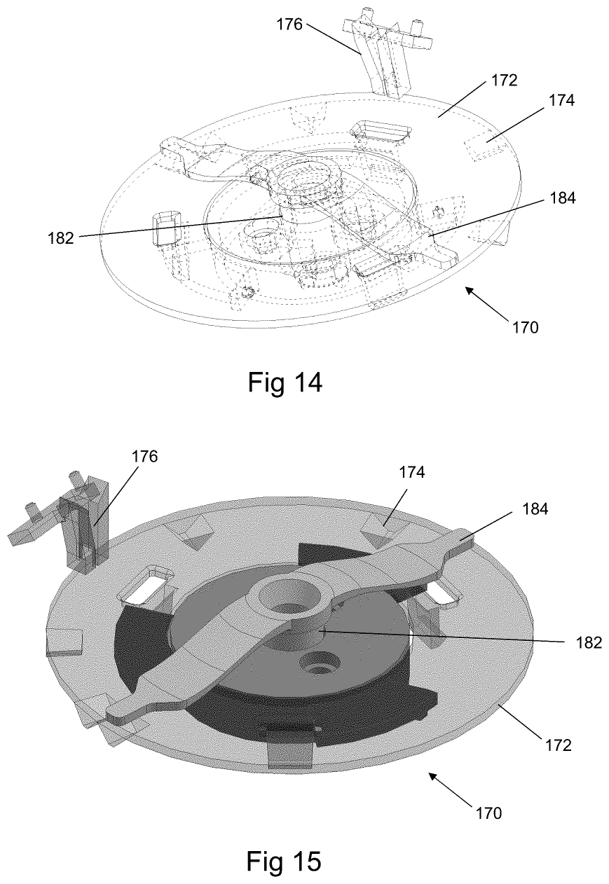

FIGS. 13a-c each show perspective views of part of the coin hopper. In particular, FIG. 13a shows the back plate 160, the exit channel, the singulator 168, and the diverter ribs 164 which protrude from the back plate 160.

In FIG. 13b the singulator 168 is removed and a sectioned view of the transporter plate 130 is shown revealing the circumferentially extending ribs 134 on the underside of the transport plate 130 which are configured to interlace with and slide between the diverter ribs 134.

FIG. 13c shows another perspective view of the back plate 160, the exit shoot 120, the singulator 168, and the transport plate 130. In this view, more of the structure of the transport plate 130 is shown, revealing a webbing which forms the three different sizes of coin pockets 132a, 132b, 132c provided in the transport plate 130.

FIGS. 14-15 show perspective views of the light pipe assembly 170 for detecting the configuration of the adjustable cover 140. As discussed above, the central post 182 which extends through the transport plate 130, comprises two flag arms 184 extending radially outward from the central post 182. The flag arms 184 are configured to rotate with the adjustable cover 140.

The light pipe arrangement 170 comprises an annular ring 172, prism reflectors 174, and a detection light pipe 176. The annular ring 172, prism reflectors 174, and detection light pipe 174 are each formed of solid transparent plastic, for example, and are configured to transmit light. The annular ring 172 is configured to remain stationary in relation the flag arms 184 such that movement of the adjustable cover 140 causes the flag arms 184 to move relative to the annular ring 172 and so cause the flag arms to block different prism reflectors 174 located around the annular ring.

FIG. 16 shows a perspective view of the light pipe assembly, which is connected, via the detection light pipe 176, to a control PCB 178. FIG. 17 shows a detailed view of the detection light pipe 176.

The control PCB comprises an LED light source which is configured to shine light down the detection light pipe 176 towards the prism reflectors 74 of the annular ring 172. As shown by the arrows in FIG. 17, the light is transmitted down the light pipe 176 to the prism reflectors 174 and from there it is transmitted back up the light pipe 176 to the control PCB 178 where it is detected using a photodiode receiver (not shown). In particular, the LED may be configured to produce red or infrared light. Therefore, when one of the flag arms 184 passes in-front of the detection light pipe 176, the arm blocks light from passing between the prism reflectors 174 and the detection light pipe 176 which can be detected by the photodiode.

Accordingly, when the coin hopper 100 is operated to dispense coins, the transport plate 130, cover 140, annular ring 172, and the flag arms 184 rotate together under the control of the motor drive system (not shown). As the annular ring 172 rotates, light from the prism reflectors 174 is detected by the control PCB 178 via the detection light pipe 174 in a predictable pattern determined by the positions of the prism reflectors 174 and the flag arms 184.

Therefore, as the cover 140 is rotated to change the configuration of the coin hopper 100, the position of the flag arms 184 relative to the annular ring 172 is adjusted thereby blocking light from different prism reflectors 174 and adjusting the pattern of the light received at the photodiode. The resulting signal can be compared to a motor encoder of the motor drive system as a baseline to generate a code which is indicative of the position of the flag arms 184 and hence the configuration of the adjustable cover 140. The configuration may then be communicated to users for ensuring that the coin hopper 100 is configured correctly for dispensing the denomination of coins that have been installed in it.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the words “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

What is claimed is:

1. A coin hopper (100) for dispensing coins, the coin hopper comprising:
a container (110) for holding a plurality of coins;
an exit channel (120) for outputting a target number of coins from the plurality of coins; and
a dispensing unit, the dispensing unit including a rotatable transport plate (130) located between the container (110) and the exit channel (120), wherein the transport plate (130) comprises a plurality of coin pockets (132), each coin pocket (132) for receiving a dispense coin from the container (110), such that rotation of the transport plate (130) causes the dispense coin to be transported from the container (110) to the exit channel (120);
the plurality of coin pockets (132) includes a first coin pocket configured to receive a dispense coin of a first size and a second coin pocket configured to receive a dispense coin of a second size, and
the dispensing unit further comprises a cover (140) adjustably connected to the transport plate (130) for selectively covering a portion of the transport plate (130),
wherein the cover (140) is movable between: a first configuration in which the first coin pocket is exposed to the container (110) and the second coin pocket is blocked from the container (110) by the cover (140), and a second configuration in which the first coin pocket is blocked from the container (110) by the cover (140) and the second coin pocket is exposed to the container (110), thereby permitting selective configuration of the coin hopper (100) for dispensing the target number of coins of the first size in the first configuration or the target number of coins of the second size in the second configuration.

2. The coin hopper (100) according to claim 1 wherein the plurality of coin pockets (132) comprises:
a plurality of first coin pockets (132) each configured to receive a dispense coin the first size, and a plurality of second coin pockets (132) each configured to receive a dispense coin the second size, such that:
in the first configuration, the first coin pockets (132) are exposed to the container (110) by the cover (140) and the remaining coin pockets (132) are blocked from the container (110) by the cover (140), and
in the second configuration, the second coin pockets (132) are exposed to the container (110) by the cover (140) and the remaining coin pockets (132) are blocked from the container (110) by the cover (140).

3. The coin hopper (100) according to claim 1 or 2 wherein:
the plurality of coin pockets (132) comprises a third coin pocket configured to receive a dispense coin of a third size,
when the cover (140) is in the first or second configurations, the third coin pocket is blocked from the container (110) by the cover (140), and
the cover (140) is movable to a third configuration in which the third coin pocket is exposed to the container (110), and the first and second coin pockets (132) are blocked from the container (110) by the cover (140).

4. The coin hopper (100) according to any preceding claim, wherein the cover (140) is movable between each configuration by rotation of the cover (140) relative to the transport plate (130).

5. The coin hopper (100) according to any preceding claim wherein the cover (140) is a plate comprising selection apertures for exposing selected coin pockets (132) in the transport plate (130), wherein each selection aperture is larger than each of the plurality of coin pockets (132) in the transport plate (130).

6. The coin hopper (100) according to any preceding claim further comprising a locking mechanism configured to lock the cover (140) in each of the configurations.

7. The coin hopper (100) according to claim 6 wherein the locking mechanism includes a central locking boss (150) comprising a gripping member connected to one or more locking arms (154),
wherein the locking arms (154) are configured to pass through respective openings in the cover (140) and engage with the transport plate (130) thereby securing the cover (140) between the gripping member and the transport plate (130).

8. The coin hopper (100) according to claim 7 wherein the central locking boss (150) is movable between:
a locked position in which the gripping member (152) is flush with the cover (140), the cover (140) is flush with the transport plate (130), and the locking arms 154 are engaged with the transport plate (130) thereby securing the cover (140) to the transport plate (130), and
an unlocked position wherein the gripping member (152) is displaced away from the transport plate (130) thereby disengaging the locking arms (154) from the transport plate (130) and enabling movement of the cover (140) relative to the transport plate (130).

9. The coin hopper (100) according to claim 8 wherein the locking arms (154) are configured to remain within the respective openings (144) in the cover (140) when the locking boss (150) is in the unlocked configuration such that when the gripping member (152) is in the unlocked position, movement of the locking boss (150) relative to the transport plate (130) results in a corresponding movement of the cover (140) and vice versa.

10. The coin hopper (100) according to any preceding claim further comprising a detection mechanism configured to detect the configuration of the cover (140).

11. The coin hopper (100) according to claim 10 wherein the detection mechanism comprises one or more flag arms (184) configured to move relative to the cover (140).

12. The coin hopper (100) according to claim 11 further comprising a central post (182) extending through the transport plate (130) and the cover (140),
wherein the one or more flag arms extend radially from the central post on an underside of the transport plate (130) which is distal to the cover (140),
wherein the central post (182) is connected to the cover (140) such that rotation of the cover (140) relative to the transport plate (130) causes a corresponding rotation of the central post (182) and the one or more flag arms (184).

13. The coin hopper (100) according to claim 12 wherein the detection mechanism comprises a light pipe 170 configured to determine a location of the one or more flag arms (184) relative to the transport plate (130), wherein the detection mechanism is configured to determine the configuration of the cover (140) based on the location of the flag arms (182).

14. The coin hopper (100) according to any preceding claim wherein an edge of the container (110) proximal to the transport plate (130) comprises a resiliently biased bridging member (112) configured to extend towards the transport plate (130).

15. An automatic transaction machine for administering monetary transactions, the automatic transaction machine comprising one or more coin hoppers (100) according to any preceding claim.
